(19) United States
(12) Patent Application Publication
(10) Pub. No.: US 2024/0320776 A1
(43) Pub. Date: Sep. 26, 2024

(54) QUALITY OF SERVICE CONTROL SCHEME FOR ACCESS TO MEMORY BY IMAGE SIGNAL PROCESSOR

(71) Applicant: Apple Inc., Cupertino, CA (US)

(72) Inventors: Hoi Man S. Ng, San Ramon, CA (US); Oren Kerem, Sunnyvale, CA (US); Wayne Eric Burk, San Jose, CA (US); Michael Bekerman, Los Gatos, CA (US); Marc A Schaub, Sunnyvale, CA (US)

(21) Appl. No.: 18/125,046

(22) Filed: Mar. 22, 2023

(51) Int. Cl. G06T 1/20

(52) U.S. Cl. CPC G06T 1/20

(57) ABSTRACT

Embodiments relate to generating a Quality of Service (QOS) parameter indicating latency tolerance of an image signal processor by determining and processing latency tolerance values of its individual pipeline circuits. At least a subset of the pipeline circuits that performs image processing functions generates their individual latency tolerance values. Each of the individual latency tolerance value is determined as a difference between a sampling time at which an operation is performed on certain pixel data and a latest time by which the operation should be performed on the same pixel data. The individual latency tolerance values generated in this manner provides a mechanism to determine the QoS parameter relevant to an image signal processing scheme that involves access to memory multiple times to save and retrieve intermediate pixel data and process incoming pixel data in a real-time manner.

### BACKGROUND

### 1. Field of the Disclosure

The present disclosure relates to a transmission of data to or from memory by an image signal processor, and more specifically to a scheme for assessing quality of service associated with pixel data transmission between the memory and the image signal processor. sensors.

### 2. Description of the Related Arts

Image data captured by an image sensor or received from other data sources is often processed in an image processing pipeline before further processing or consumption. For example, raw image data may be corrected, filtered, or otherwise modified before being provided to subsequent components such as a video encoder. To perform corrections or enhancements for captured image data, various components, unit stages or modules may be employed.

Such an image processing pipeline may be structured so that corrections or enhancements to the captured image data can be performed in an expedient way without consuming other system resources. Although many image processing algorithms may be performed by executing software programs on a central processing unit (CPU), execution of such programs on the CPU would consume significant bandwidth of the CPU and other peripheral resources as well as increase power consumption. Hence, image processing pipelines are often implemented as a hardware component separate from the CPU and dedicated to perform one or more image processing algorithms.

When implemented as separate hardware component, the image processing pipelines may communicate with memory over bus or other communication pathways that have restricted bandwidth and availability. Hence, Quality of Service (QOS) parameters may be adopted to indicate quality of the communication of the image processing pipelines over the bus. The QoS parameters may be used to ensure that the image processing pipelines are given access to the memory and the bus for their proper operations.

### SUMMARY

Embodiments relate to an image signal processor having pipeline circuits that generate individual latency tolerance values and a latency quality of service circuit that determines determine an overall latency value for the image signal process based on the individual latency tolerance values. The image signal processor includes an image pipeline circuit that performs image signal processing on first pixel data to generate second pixel data. The image pipeline circuit determines a part of the first pixel data or the second pixel data undergoing an operation by the image pipeline circuit at a sampling time. As a result, the image pipeline circuit generates the latency tolerance value indicative of a difference between the sampling time and a first latest time by which the operation should be performed by the first circuit. The latency quality of service circuit receives the latency tolerance value, and determines the overall latency value as a function of at least the latency tolerance value. The overall latency value is sent to a memory controller that controls access of the image signal processor to memory.

### BRIEF DESCRIPTION OF THE DRAWINGS

Figure (FIG. 1 is a high-level diagram of an electronic device, according to one embodiment.

FIG. 2 is a block diagram illustrating components in the electronic device, according to one embodiment.

FIG. 3 is a block diagram illustrating image processing pipelines implemented using an image signal processor, according to one embodiment.

FIG. 4 is a timing diagram illustrating relationships between a sampling time during an operation on one or more pixels and a latest time by which the same operation should be performed, according to one embodiment.

FIG. 5 is a flowchart illustrating a process of determining and sending an overall latency tolerance value of the image signal processor, according to one embodiment.

The figures depict, and the detailed description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments relate to generating a Quality of Service (QOS) parameter indicating latency tolerance of an image signal processor by determining and processing latency tolerance values of its individual pipeline circuits. At least a subset of the pipeline circuits performing image processing generates individual latency tolerance values. Each of the individual latency tolerance value is determined as a difference between a sampling time at which an operation is performed on certain pixel data and a latest time by which the operation should be performed on the same pixel data. The individual latency tolerance values generated in this manner provides a mechanism to determine the QoS parameter relevant to an image signal processing scheme that involves access to memory multiple times to save and retrieve intermediate pixel data and process incoming pixel data in a real-time manner.

### Example Electronic Device

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Example embodiments of portable multifunction devices include, without limitation, the iPhone®, iPod Touch®, Apple Watch®, and iPad® devices from Apple Inc. of Cupertino, California. Other portable electronic devices include wearables, laptops or tablet computers. In some embodiments, the device is not a portable communications device, but is a desktop computer or other computing device that is not designed for portable use. In some embodiments, the disclosed electronic device may include a touch sensitive surface (e.g., a touch screen display and/or a touch pad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

Figure (FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. The device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors that may be used for face recognition. In addition or alternatively, the image sensors 164 may be associated with different lens configuration. For example, device 100 may include rear image sensors, one with a wide-angle lens and another with as a telephoto lens. The device 100 may include components not shown in FIG. 1 such as an ambient light sensor, a dot projector and a flood illuminator.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application specific integrated circuits (ASICs). While the components in FIG. 1 are shown as generally located on the same side as the touch screen 150, one or more components may also be located on an opposite side of device 100. For example, the front side of device 100 may include an infrared image sensor 164 for face recognition and another image sensor 164 as the front camera of device 100. The back side of device 100 may also include additional two image sensors 164 as the rear cameras of device 100.

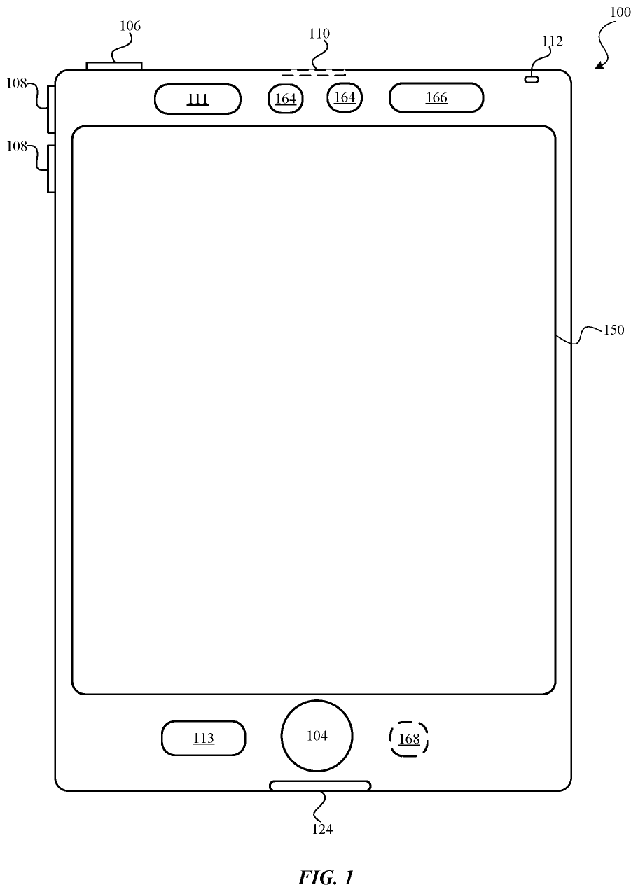

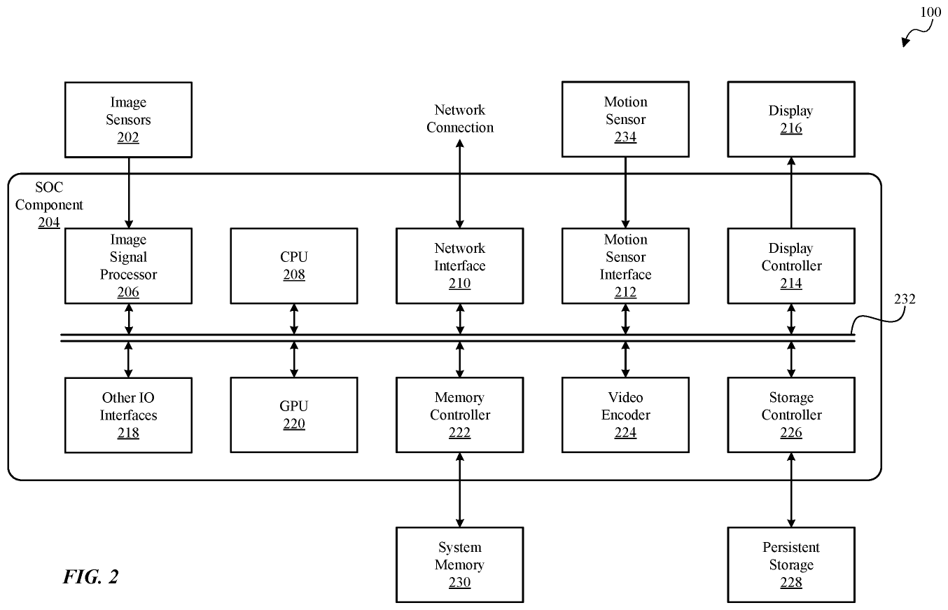

FIG. 2 is a block diagram illustrating components in device 100, according to one embodiment. Device 100 may perform various operations including image processing. For this and other purposes, the device 100 may include, among other components, image sensor 202, system-on-a chip (SOC) component 204, system memory 230, persistent storage (e.g., flash memory) 228, orientation sensor 234, and display 216. The components as illustrated in FIG. 2 are merely illustrative. For example, device 100 may include other components (such as speaker or microphone) that are not illustrated in FIG. 2. Further, some components (such as orientation sensor 234) may be omitted from device 100.

Image sensors 202 are components for capturing image data. Each of the image sensors 202 may be embodied, for example, as a complementary metal-oxide-semiconductor (CMOS) active-pixel sensor, a camera, video camera, or other devices. Image sensors 202 generate raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensors 202 may be in a Bayer color filter array (CFA) pattern (hereinafter also referred to as “Bayer pattern”) or a Quad Bayer pattern. An image sensor 202 may also include optical and mechanical components that assist image sensing components (e.g., pixels) to capture images. The optical and mechanical components may include an aperture, a lens system, and an actuator that controls the lens position of the image sensor 202.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, a liquid crystal display (LCD) device or an organic light emitting diode (OLED) device. Based on data received from SOC component 204, display 216 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. In some embodiments, system memory 230 may store pixel data or other image data or statistics in various formats.

Persistent storage 228 is a component for storing data in a non-volatile manner. Persistent storage 228 retains data even when power is not available. Persistent storage 228 may be embodied as read-only memory (ROM), flash memory or other non-volatile random access memory devices.

SOC component 204 is embodied as one or more integrated circuit (IC) chip and performs various data processing processes. SOC component 204 may include, among other subcomponents, image signal processor (ISP) 206, a central processing unit (CPU) 208, a network interface 210, motion sensor interface 212, display controller 214, graphics processor (GPU) 220, memory controller 222, video encoder 224, storage controller 226, and various other input/output (I/O) interfaces 218, and bus 232 connecting these subcomponents. SOC component 204 may include more or fewer subcomponents than those shown in FIG. 2.

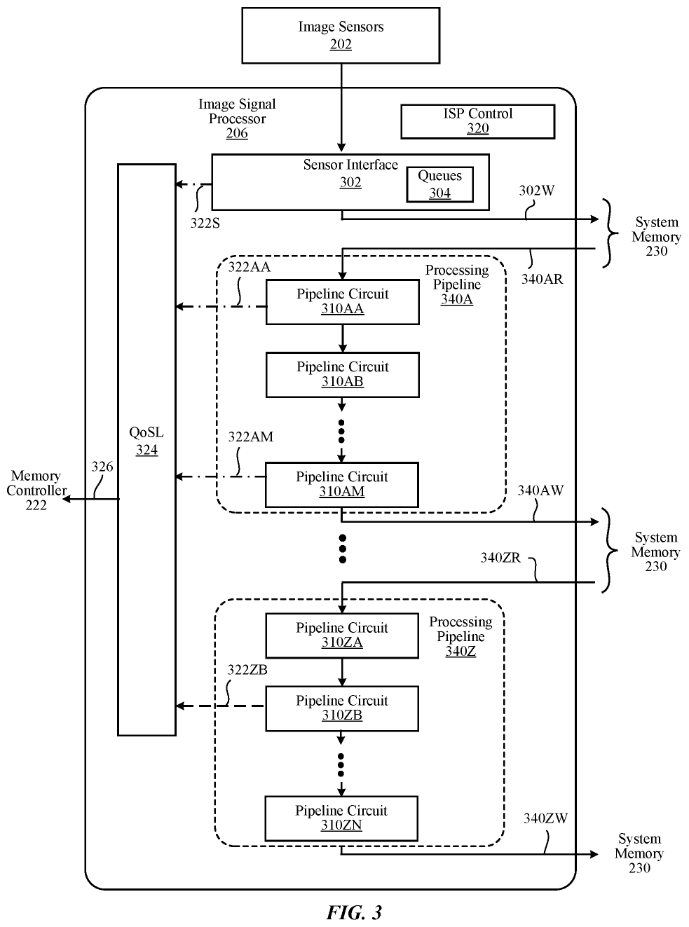

ISP 206 is hardware that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations, as described below in detail with reference to FIG. 3.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing operations on graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

I/O interfaces 218 are hardware, software, firmware or combinations thereof for interfacing with various input/output components in device 100. I/O components may include devices such as keypads, buttons, audio devices, and sensors such as a global positioning system. I/O interfaces 218 process data for sending data to such I/O components or process data received from such I/O components.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206, such as discussed below in FIG. 3) and display. The networks may include, but are not limited to, Local Area Networks (LANs) (e.g., an Ethernet or corporate network) and Wide Area Networks (WANs). The image data received via network interface 210 may undergo image processing processes by ISP 206.

Motion sensor interface 212 is circuitry for interfacing with motion sensor 234. Motion sensor interface 212 receives sensor information from motion sensor 234 and processes the sensor information to determine the orientation or movement of the device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204. Among other functions, memory controller 222 performs the functions of receiving circuit latency values and/or bandwidth parameters as quality of service (QOS) parameters from other SOC components 204, and allocating bandwidth and availability of connection pathways (e.g., memory bus) to system memory 230 so that access to system memory 230 may be coordinated.

Video encoder 224 is hardware, software, firmware or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on ISP 206, CPU 208 or GPU 220. Such software components may be stored in system memory 230, persistent storage 228 or another device communicating with device 100 via network interface 210.

Image data, video data or pixel data may flow through various data paths within SOC component 204. In one example, raw image data may be generated from the image sensors 202 and processed by ISP 206, and then sent to system memory 230 via bus 232 and memory controller 222. After the image data is stored in system memory 230, it may be accessed by video encoder 224 for encoding or by display 216 for displaying via bus 232.

In another example, image data is received from sources other than the image sensors 202. For example, video data may be streamed, downloaded, or otherwise communicated to the SOC component 204 via wired or wireless network. The image data may be received via network interface 210 and written to system memory 230 via memory controller 222. The image data may then be obtained by ISP 206 from system memory 230 and processed through one or more image processing pipelines. The image data may then be returned to system memory 230 or be sent to video encoder 224, display controller 214 (for display on display 216), or storage controller 226 for storage at persistent storage 228.

### Example Image Signal Processing Pipelines

FIG. 3 is a block diagram illustrating image processing pipelines implemented using ISP 206, according to one embodiment. In the embodiment of FIG. 3, ISP 206 may include, among other components, an ISP control 320, sensor interface circuit 302, processing pipelines 340A through 340Z (hereinafter collectively referred to also as “processing pipelines 340”), and Quality of Service Latency (QoSL) circuit 324. ISP 206 may include components other than what are illustrated in FIG. 3 or certain components in FIG. 3 may be omitted.

Sensor interface circuit 302 is a circuit that receives sensor data from image sensors 202 and converts the sensor data into pixel data 302W that can be processed by processing pipelines 340 or other components of SOC 204. For this purpose, sensor interface circuit 302 may include one or more queues 304 that store and buffer pixel data included in the sensor data. In one or more embodiments, pixel data 302W is sent to system memory 230 for storing before being read and further processed by processing pipelines 340. Sensor interface circuit 302 may also generate its latency tolerance value 322S indicating tolerable latency associated with its operations. Latency tolerance value 322S of sensor interface circuit 302 may, for example, indicate occupancy of available space in its queues 304.

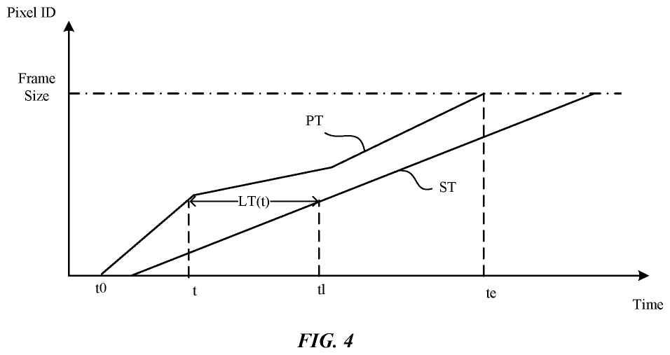

ISP control 320 is a circuit, firmware, software or a combination thereof that controls and coordinates overall operation of other components in ISP 206. ISP control 320 performs operations including, but not limited to, monitoring various operating parameters (e.g., logging clock cycles, memory latency, quality of service, and state information), updating or managing control parameters for other components of ISP 206, and interfacing with sensor interface circuit 302 to control the starting and stopping of other components of ISP 206. For example, ISP control 320 may update programmable parameters for other components in ISP 206 while the other components are in an idle state. The programmable parameters may include latest times that certain operations may be performed on pixel data by pipeline circuits 310AA through 310AM, 310ZA through 310ZN (hereinafter collectively referred to as “pipeline circuits 310”), as described below in detail with reference to FIG. 4. After updating the programmable parameters, ISP control 320 may place these components of ISP 206 into a run state to perform one or more operations or tasks.

Each of processing pipelines 340 includes a pipeline circuit or a set of pipeline circuits for performing image signal processing. At the start of each processing pipelines 340, its pipeline circuit receives pixel data from system memory 230. Conversely, at the end of each processing pipeline 340, its pipeline circuit sends a processed version of the pixel data to system memory 230 for storage. The stored pixel data may later be retrieved by a subsequent processing pipeline 340. Taking the example of FIG. 3, processing pipeline 340A includes pipeline circuit 310AA through 310AM while processing pipeline 340A includes pipeline circuit 310ZA through 310ZN. The first pipeline circuits (e.g., 310AA and 310ZA) of processing pipelines 340A, 340Z receive versions of pixel data (e.g., 340AR, 340ZR), respectively. Each of processing pipelines 340 performs image signal processing on the receive pixel data, and sends the processed pixel data from their last pipeline circuits (e.g., pipeline circuits 310AM, 310ZN) to system memory 230.

Each of pipeline circuits 310 performs a predefined image processing on pixel data. The predefined image processing performed by each pipeline circuit may include, but are not limited to, sensor linearization, black level compensation, fixed pattern noise reduction, defective pixel correction, raw noise filtering, lens shading correction, white balance gain, highlight recovery, scaling of pixel data, demosaicing, per-pixel color correction, Gamma mapping, color space conversion, noise reduction, and adjusting of color information in the pixel data. In some embodiments, only a subset of these processing scheme may be adopted by ISP 206 or different subsets of image processing schemes may be used.

QoSL circuit 324 receives individual latency values from all or a subset of pipeline circuits 310. In the example of FIG. 3, only a subset of pipeline circuits 310AA, 310AM, 310ZB generates and sends their individual latency values 322AA, 322AM, 322ZB (hereinafter collectively referred to as “individual latency values 322”) to QoSL circuit 324. QoSL circuit 324 determines an overall latency values 326, and sends it to memory controller 222.

In one or more embodiments, the writing or reading of pixel data may be tightly coupled between its source circuit and target circuit to reduce the size of pixel data buffered in system memory 230. That is, the reading of pixel data from the target circuit is closely synchronized with writing of pixel data by the source circuit. For example, writing of pixel data 320W from sensor interface circuit 302 (functioning as a source circuit) to system memory 230 and reading of pixel data 340AR (corresponding to stored pixel data 320W) from system memory 230 by pipeline circuit 310AA are closely synchronized. In this way, the footprint of memory in system memory 230 used for buffering and exchanging pixel data between sensor interface circuit 302 and processing pipeline 340A and exchanging pixel data between processing pipelines 340 may be reduced while reducing or eliminating the need of buffering memory in the processing pipelines 340.

### Example Quality of Service Scheme for Pipeline Circuit

Quality of Service (QOS) in the context of memory access (e.g., bus) refers to the level of service provided to ensure that the data is transmitted reliably, with reduced delay and increased throughput between memory and different circuit components. To ensure a level of QoS across different circuit components, QoS parameters relevant to their functions are collected and processed to arbitrate access to the memory.

In the example of image processing pipeline, one way of providing a QoS parameter is by tracking available buffer space remaining in queues of a sensor interface circuit. As long as the image processing pipeline processes the pixel data in a linear fashion across different pipeline circuits without relying on outside resources such as system memory to store intermediate pixel data, the remaining buffer space in the sensor interface circuit may function as an adequate QoS parameter for allocating the communication pathways (e.g., bus) between the image signal processor and the system memory. However, if different parts of the image processing pipelines rely upon the system memory to temporarily store intermediate pixel data, the remaining buffer space in the queues of the sensor interface circuit may not be an adequate QoS parameter for the image signal processor because these image processing pipelines also used the system memory to store or read the intermediate pixel data.

Hence, embodiments employ a latency tolerance value that is generated by a pipeline circuit to indicate an acceptable level of latency on an operation performed by the pipeline circuit. The latency tolerance value for a sampling time is determined, for example, by identifying an identity of a pixel or pixels on which the operation is being performed the pipeline circuit and the latest time by which the operation on the identified pixel or pixels should be performed by the pipeline circuit to avoid or reduce any negative impact on timely processing of the pixel data or other processes that rely upon timely processing of the pixel data.

The operation of the pipeline circuit used for determining the latency tolerance value may be the same or different across different pipeline circuits. Such operation may be one of reading of a pixel from the image sensors or the system memory, performing of a predefined image processing (e.g., noise filtering) of the pixel, or outputting of a processed pixel from the pipeline circuit. The pipeline circuit determines the identity of the pixel or pixels that are being operated at the sample time, and determines the latest times that the operation of these pixel or pixels are performed.

The latest times that the pixels or pixels should be operated on may be programmed or instructed by ISP control 320, CPU 208 or other components of device 100. The latest times does not necessarily indicate time points beyond which a failure in device 100 occurs due to the delayed processing, but instead may be defined as time points by which it is desirable to have the operations performed given various conditions of device 100.

FIG. 4 is a timing diagram illustrating relationships between a sampling time t during an operation of one or more pixels and a latest time t1 by which the same operation should be performed, according to one embodiment. In FIG. 4, the operation on one or more pixels of a frame starts at time to by a pipeline circuit (e.g., pipeline circuit 310AA, 310AM or 310ZB). The operation continues to be performed on different parts of an image frame until a termination time the when the operation on the last pixel or pixels of the image frame is performed. In the example of FIG. 4, the individual latency tolerance value of the pipeline circuit is determined at a sample time t.

Line PT indicates identity of one or more pixels of the image frame on which the operation is being performed by the pipeline circuit at different times. Line PT is shown as consisting of three different segments of different slope angles, but this is merely an example. The shape and configuration of line PT may differ depending on the type of operation as well as the upstream or downstream operations associated with the operation of the pipeline circuit.

The latest times for one or more pixels of certain identity are defined by line ST. Although line ST is indicated as a straight line with a consistent slope angle, line ST may be defined as a curve or may include multiple segments of different slope angles.

At sampling time t, the pipeline circuit determines identity of one or more pixels that are being operated on. Then, the latest time t1 by which the same one or more pixels are to be operated is determined by referencing line ST. The difference LT(t) between the latest time t1 of the one or more pixels and sampling time t is determined as the individual latency tolerance value of the corresponding operation at the pipeline circuit. After individual latency tolerance value LT(t) is determined, the pipeline circuit sends it to QoSL circuit 324. Although only one sampling time is illustrated for a frame of pixels in FIG. 4, multiple sampling times may be provided for a single image frame. Alternatively, a single sampling may be performed across multiple frames of pixels.

Sensor interface circuit 302 may generate its latency tolerance value 322S in the same way as pipeline circuits 310 or in a different way. For example, sensor interface circuit 302 may determine the identity of one or more pixels that are being received, stored in queues 304 or being output to system memory 230, and use predefined latest times to determine latency tolerance value 322S.

QoSL circuit 324 collects individual latency tolerance values (322S, 322AA, 322AM, 322ZB) generated by different pipeline circuits (e.g., 310AA, 310AM and 310ZB) at the sampling times. Then QoSL circuit 324 determines overall latency tolerance value 326 for the entire ISP 206 as a function of individual latency tolerance values and sends it to memory controller 222. Various schemes may be used to determine the overall latency tolerance value 326. For example, the smallest value of the individual latency tolerance values may be taken as overall latency tolerance value 326 for a sampling time.

Memory controller 222 receives overall latency tolerance value 326 from ISP 206 and similar parameters from other components of SOC 204, and allocates times for ISP 206 to access system memory 230.

### Example Process of Determining Overall Latency Tolerance Value

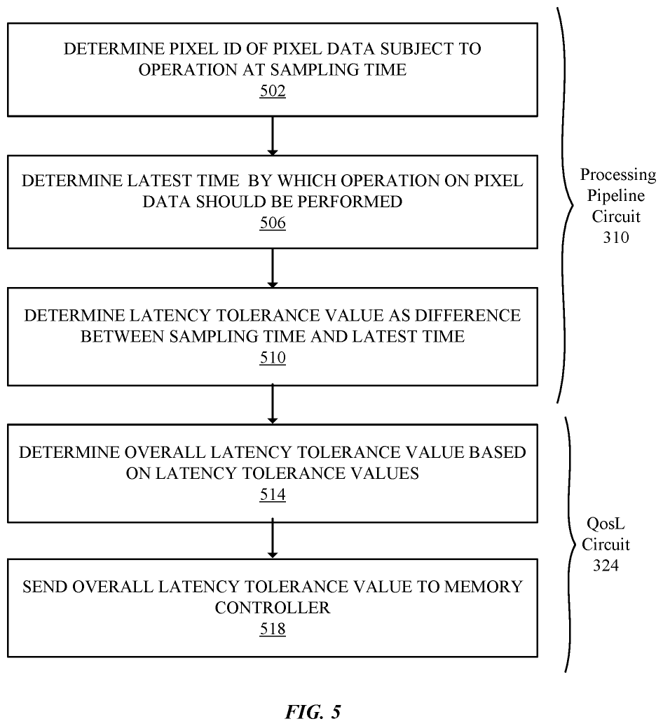

FIG. 5 is a flowchart illustrating a process of determining and sending an overall latency tolerance value of ISP 206, according to one embodiment. At a sampling time, the identity of pixel or pixels undergoing a predefined operation is determined 502. The sampling time may be determined by components of ISP 206 such as QoSL circuit 324 and ISP control 320 or other components of SOC 204.

The latest time by which operation on the pixel or pixels undergoing the predefine operation is determined 506. Information on the latest time may be provided by ISP control 320 and programmed into pipeline circuits 310. An individual latency tolerance value of a pipeline circuit is then determined 510 as a difference between the sampling time and the latest time for the same pixel or pixels.

QoSL circuit 324 collects the individual latency values from different pipeline circuits 310. Then, QoSL circuit 324 determines 514 the overall latency value of ISP 206 based on the individual latency values. In one or more embodiments, the overall latency value is determined as the smallest value of the individual latency values.

The overall latency value, as determined by QoSL circuit 324, is then sent 518 to memory controller 222 so that memory controller 222 can determine times and bandwidth for ISP 206 to access system memory 230.

The process described with reference to FIG. 5 is merely illustrative. Additional steps may be performed as part of the process or certain steps may be omitted or performed in parallel with other steps.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. An image signal processor, comprising:
a first image pipeline circuit configured to:
perform first image signal processing on first pixel data to generate second pixel data,
determine a part of the first pixel data or the second pixel data undergoing a first operation by the first image pipeline circuit at a sampling time, and
generate a first latency tolerance value indicative of a difference between the sampling time and a first latest time by which the first operation should be performed by the first image pipeline circuit; and
a latency quality of service circuit coupled to the first image pipeline circuit to receive the first latency tolerance value, the latency quality of service circuit configured to:
determine an overall latency value as a function of at least the first latency tolerance value, and
send the overall latency value to a memory controller that controls access of the image signal processor to the memory external to the image signal processor.

2. The image signal processor of claim 1, further comprising a second image pipeline circuit coupled to the memory to receive third pixel data, the second image pipeline circuit configured to:
perform second image signal processing on a version of the third pixel data to generate fourth pixel data,
determine a part of the third pixel data or the fourth pixel data undergoing a second operation by the second image pipeline circuit at the sampling time, and
generate a second latency tolerance value indicative of a difference between the sampling time and a second latest time by which the second operation should be performed by the second image pipeline circuit, wherein the overall latency value is determined further as a function of the second latency tolerance value.

3. The image signal processor of claim 2, wherein the overall latency value is a smaller value of the first latency tolerance value and the second latency tolerance value.

4. The image signal processor of claim 2, wherein the first operation is one of receiving of the part of the first pixel data, processing of the part of the first pixel data or outputting of the part of the second pixel data.

5. The image signal processor of claim 4, wherein the second operation is one of receiving of the part of the third pixel data, processing of the part of the third pixel data or outputting of the part of the fourth pixel data.

6. The image signal processor of claim 2, further comprising a sensor interface circuit configured to interface with one or more image sensors, the sensor interface circuit configured to:
generate the first pixel data,
send the first pixel data to the memory for storing,
generate a third latency tolerance value associated with sending of the first pixel data to the memory, and
send the third latency tolerance value to the memory controller for determining the overall latency value.

7. The image signal processor of claim 2, wherein the third pixel data is generated from a processed version of the second pixel data stored in the memory.

8. The image signal processor of claim 7, further comprising a third circuit coupled to the first image pipeline circuit and configured to:
receive the second pixel data,
generate the processed version of the second pixel data, and
send the processed version of the second pixel data to the memory for storage.

9. The image signal processor of claim 1, wherein the first image pipeline circuit is further configured to receive the first pixel data from the memory.

10. A method of operating an image signal processor, comprising:
performing first image signal processing on first pixel data to generate second pixel data by a first image pipeline circuit of the image signal processor;
determining a part of the first pixel data or the second pixel data undergoing a first operation by the first image pipeline circuit at a sampling time;
generating a first latency tolerance value indicative of a difference between the sampling time and a first latest time by which the first operation should be performed by the first image pipeline circuit;
sending the first latency tolerance value to a latency quality of service circuit of the image signal processor;
determining an overall latency value as a function of the first latency tolerance value and the second latency tolerance value; and
sending the overall latency value to a memory controller that controls access of the image signal processor to memory that is external to the image signal processor.

11. The method of claim 10, further comprising:
performing second image signal processing on third pixel data to generate fourth pixel data by a second image pipeline circuit of the image signal processor, responsive to receiving the third pixel from the memory;
determining a part of the third pixel data or the fourth pixel data undergoing a second operation by the second image pipeline circuit at the sampling time;
generating a second latency tolerance value indicative of a difference between the sampling time and a second latest time by which the second operation should be performed by the second image pipeline circuit; and
sending the second latency tolerance value to the latency quality of service circuit of the image signal processor, the overall latency value determined further as a function of the second latency tolerance value.

12. The method of claim 11, wherein the overall latency value is a smaller value of the first latency tolerance value and the second latency tolerance value.

13. The method of claim 11, wherein the first operation is one of receiving of the part of the first pixel data, processing of the part of the first pixel data or outputting of the part of the second pixel data.

14. The method of claim 13, wherein the second operation is one of receiving of the part of the third pixel data, processing of the part of the third pixel data or outputting of the part of the fourth pixel data.

15. The method of claim 11, further comprising:
receiving sensor data from one or more image sensors by a sensor interface circuit of the image signal processor;
processing the sensor data to generate the first pixel data;
sending the first pixel data to the memory for storing;
generating a third latency tolerance value associated with sending of the first pixel data to the memory; and
sending the third latency tolerance value to the memory controller for determining the overall latency value.

16. The method of claim 11, wherein the third pixel data is generated from a processed version of the second pixel data stored in the memory.

17. The method of claim 10, further comprising receiving the first pixel data from the memory by the first image pipeline circuit.

18. An electronic device comprising:
memory;
memory controller configured to control access to the memory;
an image signal processor comprising:
a pipeline circuit that is configured to:
perform image signal processing on first pixel data to generate second pixel data,
determine a part of the first pixel data or the second pixel data undergoing a first operation by the first image pipeline circuit at a sampling time, and
generate a latency tolerance value indicative of a difference between the sampling time and a first latest time by which the first operation should be performed by the first image pipeline circuit; and
a latency quality of service circuit coupled to the pipeline circuit to receive the latency tolerance value, the latency quality of service circuit configured to:
determine an overall latency value of the image signal processor as a function of the received latency tolerance value, and
send the overall latency value to cause the memory controller to control access of the image signal processor to the memory.

19. The electronic device of claim 18, wherein the image signal processor further comprises a second image pipeline circuit coupled to the memory to receive third pixel data, the second image pipeline circuit configured to:
perform second image signal processing on a version of the third pixel data to generate fourth pixel data,
determine a part of the third pixel data or the fourth pixel data undergoing a second operation by the second image pipeline circuit at the sampling time, and
generate a second latency tolerance value indicative of a difference between the sampling time and a second latest time by which the second operation should be performed by the second image pipeline circuit, wherein the overall latency value is determined further as a function of the second latency tolerance value.

20. The electronic device of claim 19, wherein the overall latency value is a smaller value of the first latency tolerance value and the second latency tolerance value.
